(19) United States
(12) Patent Application Publication
(10) Pub. No.: US 2026/0238260 A1
(43) Pub. Date: Aug. 13, 2026

(54) METHOD AND APPARATUS FOR CONTROLLING BEAM IN WIRELESS COMMUNICATION SYSTEM

(71) Applicant: ELECTRONICS AND TELECOMMUNICATIONS RESEARCH INSTITUTE, Daejeon (KR)

(72) Inventors: Ji Hyung KIM, Daejeon (KR); Cheulsoon KIM, Daejeon (KR); Sung-Hyun MOON, Daejeon (KR); Junghoon LEE, Daejeon (KR); Hoiyoon JUNG, Daejeon (KR); Jinkyu KANG, Yongin-si (KR)

(21) Appl. No.: 19/397,541

(22) Filed: Nov. 21, 2025

(30) Foreign Application Priority Data
Nov. 22, 2024 (KR) 1020240168374
Nov. 21, 2025 (KR) 1020250177783

(51) Int. Cl. H04B 7/04; H04B 7/06

(52) U.S. Cl. CPC H04B 7/04013; H04B 7/0639

(57) ABSTRACT

A method of a Reconfigurable Intelligent Surface (RIS) node may comprise: receiving, from a first communication node, first information indicating a phase shift determination scheme; based on the first information indicating use of a codebook as the phase shift determination scheme, receiving, from the first communication node, information on a phase shift set for phase shifts; setting phase shift values for respective reflection elements based on the phase shift set; and upon receiving data to be transmitted from the first communication node to a second communication node, reflecting the received data toward the second communication node based on the phase shift values set for the respective reflection elements.

### CROSS-REFERENCE TO RELATED APPLICATIONS

This application claims priority to Korean Patent Applications No. 10⁻²⁰²⁴-0168374, filed on Nov. 22, 2024, and No. 10⁻²⁰²⁵-0177783, filed on Nov. 21, 2025, with the Korean Intellectual Property Office (KIPO), the entire contents of which are hereby incorporated by reference.

### BACKGROUND

### 1. Technical Field

The present disclosure relates to a wireless communication technique, and more particularly, to a technique for controlling beams in a wireless communication system.

### 2. Related Art

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

After the commercialization of the fourth-generation (4G) communication system (e.g. communication system supporting LTE), a fifth-generation (5G) communication system (e.g. communication system supporting NR) using not only a frequency band of the 4G communication system (e.g. frequency band below 6 GHz) but also a higher frequency band than the frequency band of the 4G communication system (e.g. frequency band above 6 GHz) is being considered in order to handle the rapid increase in wireless data. The 5G communication system may support enhanced Mobile BroadBand (eMBB), Ultra-Reliable and Low Latency Communication (URLLC), and massive Machine Type Communication (mMTC).

Such a communication system may be designed in consideration of various scenarios, service requirements, potential system compatibility, and the like. In particular, in the 5G NR communication system, discussions on beam-based communication are actively conducted to perform broadband communication in a high-frequency band.

New types of network nodes have been considered by mobile network operators as a means to increase flexibility in network deployment. For example, Integrated Access and Backhaul (IAB) has been introduced and enhanced as a new type of network node that does not require a wired backhaul. Another type of network node may be a radio frequency (RF) repeater that simply amplifies and forwards all signals received by the node. RF repeaters have been widely deployed in various wireless communication systems to complement coverage provided by general full-stack cells. In NR, RF and Electromagnetic Compatibility (EMC) requirements for RF repeaters targeting both a frequency range 1 (FR1) and a frequency range 2 (FR2) have been defined.

Accordingly, a beam control method using an RF repeater targeting both FR1 and FR2 is required.

### SUMMARY

The present disclosure for resolving the above-described problems is directed to providing methods and apparatuses for a 5G NR repeater to control beams.

A method of a reconfigurable intelligent surface (RIS) node, according to an exemplary embodiment of the present disclosure, may comprise: receiving, from a first communication node, first information indicating a phase shift determination scheme; based on the first information indicating use of a codebook as the phase shift determination scheme, receiving, from the first communication node, information on a phase shift set for phase shifts; setting phase shift values for respective reflection elements based on the phase shift set; and upon receiving data to be transmitted from the first communication node to a second communication node, reflecting the received data toward the second communication node based on the phase shift values set for the respective reflection elements.

The receiving of the information on the phase shift set may comprise: receiving a first index indicating one codebook from among two or more codebooks; and receiving a second index indicating one phase shift set from among two or more phase shift sets included in the one codebook corresponding to the first index, wherein the phase shift values may be set based on the first index and the second index.

The method may further comprise: receiving, from the first communication node, the two or more codebooks through higher-layer signaling.

The receiving of the information on the phase shift set may comprise: receiving a group index indicating one phase shift set group among one or more phase shift set groups each including one or more phase shift sets; and receiving information on transmission powers respectively applied to one or more phase shift sets included in the one phase shift set group indicated by the group index, wherein the received data may be reflected toward the second communication node based on phase shift values set according to the group index and the information on the transmission powers.

The method may further comprise: receiving, from the first communication node, information corresponding to the one or more phase shift set groups each including one or more phase shift sets through higher-layer signaling.

The first information may further indicate a transmission power determination scheme, and the reflecting may comprise: setting, in the transmission power determination scheme indicated by the first information, phase shift values and transmission power values for the respective reflection elements; and reflecting the received data toward the second communication node based on the phase shift values and transmission power values set for the respective reflection elements.

The method may further comprise: based on the first information indicating non-use of a codebook as the phase shift determination scheme, receiving, from the first communication node, phase shift values for the respective reflection elements; and upon receiving data to be transmitted from the first communication node to the second communication node, reflecting the received data toward the second communication node based on the phase shift values for the respective reflection elements.

The method may further comprise: based on the first information further indicating a transmission power determination scheme and the first information indicating non-use of a codebook as the transmission power determination scheme, receiving, from the first communication node, information on transmission power values corresponding to the respective reflection elements, wherein the received data may be reflected toward the second communication node based on the transmission power values corresponding to the respective reflection elements and the phase shift values for the respective reflection elements.

The second communication node may be a user equipment (UE) based on the first communication node being a base station, and the second communication node may be a base station based on the first communication node being a UE.

The first information may further indicate a transmission power determination scheme, and the reflecting may comprise: determining, in the transmission power determination scheme indicated by the first information, transmission power values corresponding to the respective reflection elements; and reflecting the received data toward the second communication node based on the phase shift values and the transmission power values for the respective reflection elements.

The first information may be one bit indicating whether the phase shift determination scheme and/or the transmission power determination scheme uses a codebook.

A method of a first communication node, according to an exemplary embodiment of the present disclosure, may comprise: transmitting, to a Reconfigurable Intelligent Surface (RIS) node, first information indicating a phase shift determination scheme; transmitting, to the RIS node, information on a phase shift set for phase shifts; generating data to be transmitted to a second communication node based on the phase shift set; and transmitting the generated data to the RIS node.

The first information may indicate use of a codebook as the phase shift determination scheme, and the transmitting of the information on the phase shift set may comprise: transmitting, to the RIS node, a first index indicating one codebook from among two or more codebooks; and transmitting, to the RIS node, a second index indicating one phase shift set from among two or more phase shift sets included in the codebook indicated by the first index.

The method may further comprise: transmitting, to the RIS node, information indicating the two or more codebooks through higher-layer signaling.

The transmitting of the information on the phase shift set may comprise: transmitting, to the RIS node, a group index indicating one phase shift set group from among one or more phase shift set groups each including one or more phase shift sets; and transmitting, to the RIS node, information on transmission powers respectively applied to one or more phase shift sets included in the phase shift set group indicated by the group index.

The method may further comprise: transmitting, to the RIS node, information corresponding to the one or more phase shift set groups through higher-layer signaling.

The method may further comprise: based on the first information indicating non-use of a codebook as the phase shift determination scheme, transmitting, to the RIS node, phase shift values for respective reflection elements of the RIS node.

The method may further comprise: based on the first information further indicating a transmission power determination scheme, and the transmission power determination scheme indicating non-use of a codebook, transmitting, to the RIS node, transmission power values corresponding to the respective reflection elements of the RIS node.

A reconfigurable intelligent surface (RIS) node, according to an exemplary embodiment of the present disclosure, may comprise at least one processor, wherein the at least one processor may cause the RIS node to perform: receiving, from a first communication node, first information indicating a phase shift determination scheme; based on the first information indicating use of a codebook as the phase shift determination scheme, receiving, from the first communication node, information on a phase shift set for phase shifts; setting phase shift values for respective reflection elements based on the phase shift set; and upon receiving data to be transmitted from the first communication node to a second communication node, reflecting the received data toward the second communication node based on the phase shift values set for the respective reflection elements.

The at least one processor may further cause the RIS node to perform: receiving a first index indicating one codebook from among two or more codebooks; and receiving a second index indicating one phase shift set from among two or more phase shift sets included in the one codebook corresponding to the first index, wherein the phase shift values may be set based on the first index and the second index.

According to exemplary embodiments of the present disclosure, an RIS node may receive data to be transmitted from a first communication node to a second communication node, perform phase shifts and amplification on the received data, and transmit the phase-shifted and amplified data to the second communication node. In this case, configuration information for the phase shifts and amplification may be received from the first communication node, thereby preventing changes in channel conditions and/or waste of transmission power. In addition, when various methods that are available for phase shifts and amplification on the received data exist, the methods can be configured explicitly or implicitly. Through this, smooth communication between the first communication node and the second communication node can be provided, and interference with other communication nodes can be reduced.

Furthermore, even when the second communication node is located in a shadowed area of the first communication node, a communication service can be provided by using an RIS node. In this case, there is an advantage in that phase shifting and transmission power determination of the RIS node can be determined according to each situation. Through this, phase shifting and transmission power at the RIS node can be optimized.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating an example of a time-frequency region structure, which is a wireless resource region of a 5G communication system.

FIG. 4 is a conceptual diagram illustrating an example of a structure of one RB composed of one slot in a 5G communication system.

FIG. 5 is a sequence diagram illustrating transmission of data by applying phase shifts to an RIS node according to an exemplary embodiment of the present disclosure.

FIG. 6 is a sequence diagram illustrating a first exemplary embodiment of the present disclosure in which an RIS node applies phase shifts and transmission powers to transmit data.

FIG. 7 is a sequence diagram illustrating a second exemplary embodiment of the present disclosure in which an RIS node applies phase shifts and transmission powers to transmit data.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

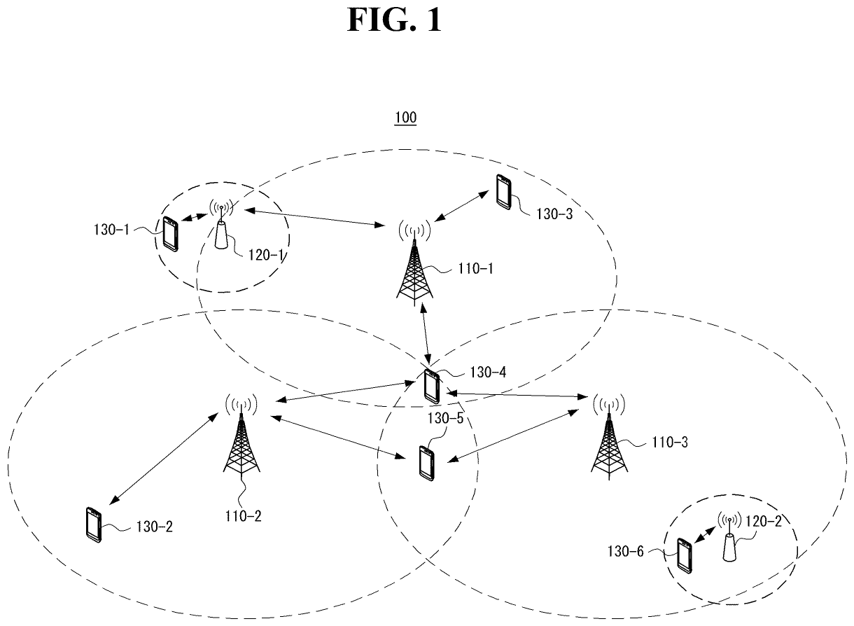

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHz, and the 5G communication may be performed in frequency bands above 6 GHz as well as frequency bands below 6 GHz.

For example, in order to perform the 4G communication and 5G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

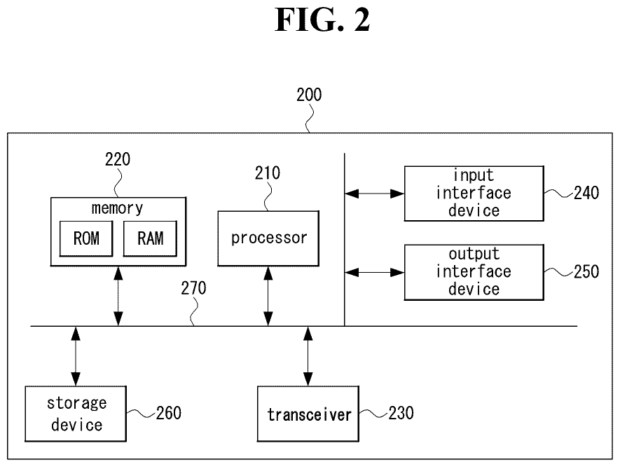

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In the present disclosure, a phrase including “when ~” may be expressed as a phrase including “based on ~” or a phrase including “in response to ~”. In other words, a phrase including “when ~” may be interpreted as being the same as or similar to a phrase including “based on ~” or a phrase including “in response to ~”.

Meanwhile, a wireless communication system has evolved from providing initial voice-oriented services to a broadband wireless communication system that provides high-speed, high-quality packet data services. Technologies for providing high-speed, high-quality packet data services include, for example, High Speed Packet Access (HSPA) of 3GPP, Long Term Evolution (LTE) (or Evolved Universal Terrestrial Radio Access (E-UTRA)), LTE-Advanced (LTE-A), LTE-Pro, High Rate Packet Data (HRPD) and Ultra Mobile Broadband (UMB) of 3GPP2, and IEEE 802.16e.

In an LTE system, which is a representative example of a broadband wireless communication system, Orthogonal Frequency Division Multiplexing (OFDM) is employed in a downlink (DL), and single carrier frequency division multiple access (SC-FDMA) is employed in an uplink (UL). The uplink refers to a wireless link through which a terminal (e.g. a user equipment (UE) or a mobile station (MS)) transmits data or a control signal to a base station (e.g. an eNode B (eNB) or a base station (BS)). The downlink refers to a wireless link through which a base station transmits data or a control signal to a terminal. In addition, the above-described multiple access schemes may allow data or control information of each user to be distinguished by allocating and operating resources such that time-frequency resources carrying data or control information for each user do not overlap with each other, that is, such that orthogonality is satisfied.

A 5G communication system, which is a wireless communication system after LTE, needs to support services that satisfy various requirements simultaneously in order to flexibly reflect various requirements of users and service providers. The services considered for the 5G communication system include enhanced mobile broadband communication (eMBB), massive machine type communication (MTC), and ultra reliability low latency communication (URLLC).

The eMBB aims to provide data transmission rates further improved compared to data transmission rates supported by the existing LTE, LTE-A, or LTE-Pro. For example, in the 5G communication system, the eMBB needs to be able to provide a maximum transmission rate (i.e. peak data rate) of 20 Gbps in a downlink from the perspective of one base station and a maximum transmission rate of 10 Gbps in an uplink. In addition, the 5G communication system needs to provide an increased user perceived data rate while providing the maximum transmission rate. In order to satisfy such requirements, enhancement of various transmission and reception technologies, including further improved multi-input multi-output (MIMO) transmission technology, may be required. In addition, while a signal is transmitted by using a maximum transmission bandwidth of 20 MHz in a 2 GHz band in the LTE system, the 5G communication system satisfies data transmission rates required in the 5G communication system by using a frequency band wider than 20 MHz in a frequency band of 3 GHz to 6 GHz or 6 GHz or higher.

When a base station supports a broadband frequency bandwidth, a technique of dividing an entire carrier frequency band into multiple frequency bandwidth parts (BWPs) supported by each terminal has been highlighted as important. For example, when bandwidth capability of a terminal is small, a base station supporting BWPs may support a small frequency band to the terminal based on the bandwidth capability of the terminal. In addition, the base station may reduce energy consumption of the terminal by communicating with the terminal by reducing a frequency band through BWP switching.

In addition, the base station may support different frame structures for respective BWPs. Supporting different frame structures for respective BWPs by the base station has an effect of supporting various services without latency to one terminal through BWP switching. As such, BWP technology may be applied to a control channel or a data channel that corresponds one-to-one between a given terminal and a base station. In addition, when the base station separately configures a BWP for transmitting common signals transmitted to multiple terminals in a system and a BWP for transmitting data, energy of the base station may be reduced. For example, the common signals transmitted to multiple terminals may include a synchronization signal, a physical broadcast channel (PBCH), and system information (SI).

In the 5G communication system, mMTC is considered to support application services such as Internet of Things (IoT). mMTC requires support for access of a massive number of terminals within a cell, improvement of coverage of terminals, enhanced battery time, and reduction of terminal costs in order to efficiently provide IoT services. Since IoT services provide communication functions by attaching various sensors to various communication devices, a large number of terminals within a cell (e.g. 1,000,000 terminals per square kilometer) may need to be supported. In addition, terminals supporting mMTC have a high possibility of being located in shadow areas not covered by a cell, such as underground areas of buildings, due to characteristics of services, and therefore require wider coverage compared to other services provided by the 5G communication system. The terminals supporting mMTC may need to be configured as low-cost terminals, and since batteries of the terminals are difficult to be replaced frequently, very long battery lifetime (e.g. a battery lifetime of 10 years to 15 years) is required.

The URLLC is a cellular-based wireless communication service used for a specific mission-critical purpose. For example, services used for remote control of robots or machinery, industrial automation, unmanned aerial vehicles, remote health care, emergency alerts, and the like may be considered. Therefore, communication provided by URLLC needs to provide very low latency and very high reliability. For example, services supporting URLLC need to satisfy an air interface latency smaller than 0.5 milliseconds, and simultaneously satisfy a packet error rate requirement of 10⁻⁵ or less. Accordingly, in order to support services supporting URLLC, the 5G system needs to provide a smaller transmit time interval (TTI) than other services, and simultaneously allocate wide resources in a frequency band to secure reliability of a communication link.

Three services of the 5G communication system (hereinafter used interchangeably with a 5G system), that is, eMBB, URLLC, and mMTC, may be performed by being multiplexed in one system. In this case, in order to satisfy different requirements of respective services, different transmission and reception schemes and transmission and reception parameters may be used among services.

Hereinafter, a frame structure of a 5G communication system is described with reference to the accompanying drawings.

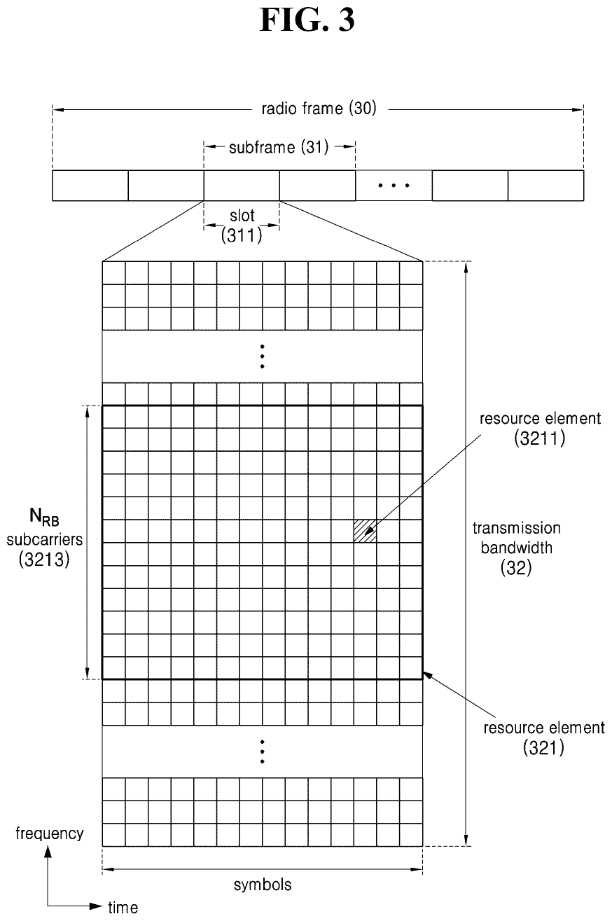

FIG. 3 is a conceptual diagram illustrating an example of a time-frequency region structure, which is a wireless resource region of a 5G communication system.

Referring to FIG. 3, one axis (e.g. a horizontal axis) may represent the time domain, and another axis (e.g. a vertical axis) may represent the frequency domain. A radio frame 30 may have a fixed time length of 10 milliseconds (ms) and may be composed of 10 subframes each having a time length of 1 ms. One subframe 31 may be composed of one or two or more slots. Whether one subframe 31 is composed of one slot or two or more slots may vary depending on a numerology (i.e. subcarrier spacing (SCS)). In the 5G communication system, SCSs of 15 kHz, 30 kHz, 60 kHz, 120 kHz, and 240 kHz may be used. Examples of cases in which one subframe 31 is composed of one or two or more slots according to SCS are as follows. When SCS is 15 kHz, one subframe may be composed of one slot. When SCS is 30 kHz, one subframe may be composed of two slots. When SCS is 60 kHz, one subframe may be composed of four slots. When SCS is 120 kHz, one subframe may be composed of eight slots. Since FIG. 3 illustrates a case in which one subframe 31 is composed of two slots, SCS may be 30 kHz.

One slot 311 may be composed of 14 consecutive OFDM symbols on the time axis. Alternatively, one slot 311 may be composed of 14 consecutive discrete Fourier transform-spread-OFDM (DFT-s-OFDM) symbols on the time axis. In the following description, for convenience of description, a case is assumed in which 14 consecutive OFDM symbols are used within a slot on the time axis.

Referring to the configuration within one slot 311 illustrated in FIG. 3, the configuration may be composed of resource elements (REs) 3211 each including one OFDM symbol and one subcarrier. In the 5G communication system, a resource allocation unit may be a resource block (RB) 321. In the 5G communication system, an RB is defined as 12 consecutive REs in the frequency domain. In the 5G communication system, an RB is defined only with respect to the frequency domain and is not defined with respect to the time domain. A reason why a time-domain unit is not defined for the RB 321 in the 5G communication system is that various services described above (e.g. eMBB, mMTC, and URLLC) need to be provided through flexible scheduling.

A transmission bandwidth 32 illustrated in FIG. 3 may correspond to a bandwidth of a BWP configured for communication with a specific terminal. As another example, the transmission bandwidth 32 illustrated in FIG. 3 may correspond to an entire bandwidth supported by a base station. The transmission bandwidth 32 may be composed of NBW subcarriers. In addition, one RB 321 may be composed of NRB subcarriers 3213. Accordingly, NRB subcarriers 3213 may correspond to 12 consecutive subcarriers.

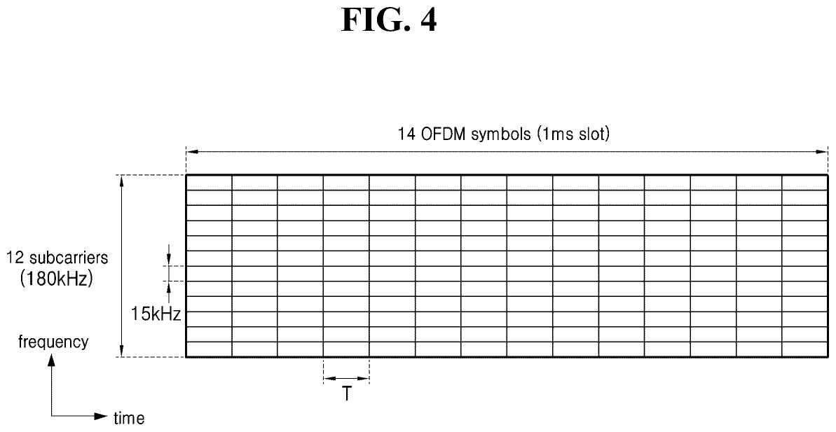

FIG. 4 is a conceptual diagram illustrating an example of a structure of one RB composed of one slot in a 5G communication system.

Referring to FIG. 4, one axis (e.g. a horizontal axis) may represent the time domain, and another axis (e.g. a vertical axis) may represent the frequency domain. According to an example of FIG. 4, one RB structure composed of 12 subcarriers in one slot including 14 OFDM symbols is illustrated. In FIG. 4, a case in which one subcarrier has a width of 15 kHz is illustrated. In other words, SCS may be 15 kHz. Accordingly, a total bandwidth of subcarriers constituting an RB may be 180 kHz. As such, when SCS is 15 kHz, one slot may have a periodicity of 1 ms. In FIG. 4, a transmission time duration of one symbol is illustrated as T.

Based on FIG. 3 and FIG. 4 described above, when a number

$${N}_{s y m b}^{slot}$$

of OFDM symbols within a slot per SCS, a number

$${N}_{slot}^{frame , μ}$$

of slots included in one radio frame per SCS, and a number

$${N}_{slot}^{s u bframe , μ}$$

of slots in a subframe per SCS are summarized, an example may be shown as Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

In Table 1, a case in which μ is 0 corresponds to a case in which SCS is 15 kHz, a case in which μ is 1 corresponds to a case in which SCS is 30 kHz, a case in which μ is 2 corresponds to a case in which SCS is 60 kHz, a case in which μ is 3 corresponds to a case in which SCS is 120 kHz, a case in which μ is 4 corresponds to a case in which SCS is 240 kHz, and a case in which μ is 5 corresponds to a case in which SCS is 480 kHz.

As illustrated in Table 1 above, when μ is 0 and SCS is 15 kHz, the number of slots within a radio frame is 10, and one subframe may be composed of one slot. When μ is 1 and SCS is 30 kHz, the number of slots within a radio frame is 20, and one subframe may be composed of two slots. In the same manner, when μ is 5 and SCS is 480 kHz, the number of slots within a radio frame is 320, and one subframe may be composed of 32 slots.

Meanwhile, in 5G NR, a scheme of delivering a precoding matrix indicator (PMI) is essential for efficient beamforming and channel state information (CSI) reporting in a MIMO system. PMI is generally transmitted from a UE to a base station (gNodeB) through an uplink shared channel (UL-SCH), and actual CSI feedback information may be delivered through a physical uplink shared channel (PUSCH). Specifically, PMI is an indicator for reporting an optimal precoding matrix selected by the UE based on a channel state, and may be used to optimize beamforming performance in the NR system. In particular, PMI may be delivered together with a rank indicator (RI) and a channel quality indicator (CQI), thereby enabling the base station to perform an optimal transmission mode and beamforming configuration in MIMO transmission. The PMI delivery procedure may be performed as follows.

(1) The UE may receive a channel state information reference signal (CSI-RS) transmitted from the base station and may measure a channel state. The CSI-RS may be periodically transmitted from the base station. The UE may receive and measure the periodically transmitted CSI-RS. The UE may analyze characteristics of a channel based on CSI-RS measurement and may generate required channel state information (CSI).

(2) The UE may evaluate a channel state based on the received CSI-RS and may calculate a CSI feedback including PMI, CQI, and RI. PMI calculation is a process of selecting an optimal vector among precoding vectors defined in a codebook, and the UE may determine an optimal PMI by calculating a correlation between precoding vectors in the codebook and a channel response.

(3) The base station may transmit a downlink control information (DCI) message to the UE through a physical downlink control channel (PDCCH). The DCI may include a field (or an indicator) requesting transmission of CSI feedback from the UE. The DCI may further include information for indicating a time and resources at which the UE transmits feedback information by using a PUSCH.

(4) The UE may transmit the CSI feedback including PMI through a PUSCH according to the resource allocated by the base station via the DCI. PUSCH may be the main channel for transmitting uplink data from the UE to the base station, and the UE may transmit PMI, CQI, and RI to the base station through PUSCH. In other words, the UE may report the CSI to the base station.

Through the procedures described above, the base station may receive the CSI including PMI information. The base station may adjust a CSI reporting periodicity according to the channel state, and efficiency may be increased by using a combination of periodic CSI reporting and aperiodic CSI reporting as necessary. The periodic CSI reporting (or CSI feedback) may be mainly used when detecting basic channel state changes, and the aperiodic CSI reporting (or CSI feedback) may support immediate CSI updating in the case of abrupt channel changes or a specific transmission situation. PMI included in the periodic CSI report and the aperiodic CSI report may be provided to the base station, and the base station may increase transmission efficiency adaptively based on the PMI. In particular, accurate PMI may allow the base station to select an appropriate beamforming vector, thereby minimizing interference in a multi-user MIMO environment and achieving optimal transmission performance.

A method of calculating PMI in the CSI feedback calculation corresponding to the procedure of (2) described above is described in more detail as follows.

PMI calculation may be performed differently according to a Type I codebook and a Type II codebook in 5G NR. Each of the Type I codebook and the Type II codebook is designed to exhibit optimal beamforming performance in a specific MIMO environment. PMI may be an indicator for optimizing beamforming by selecting the most suitable precoding vector from a codebook and feeding back the precoding vector to the base station (gNodeB).

### [A] PMI Calculation According to a Type I Codebook

The Type I codebook is optimized for low-dimensional MIMO systems and is mainly designed to allow a UE to transmit PMI feedback to a base station with low overhead in a simple channel environment. The Type I codebook provides PMI feedback for an entire band and has a relatively simple structure.

The UE may receive a CSI-RS transmitted by the base station and may measure a channel response. The CSI-RS may reflect path characteristics between multiple antennas, and based on the path characteristics, channel responses of respective antennas may be collected.

The Type I codebook may have a plurality of predefined precoding vector sets. Each precoding vector in the Type I codebook is intended to concentrate a signal in a specific beam direction. The UE may calculate correlations between the precoding vectors of the codebook and the channel response. Such calculation may be performed by calculating an inner product between a precoding vector and a channel response vector to find a vector most suitable for the channel characteristics. The UE may select, as PMI, a precoding vector having the highest correlation value based on the inner-product values. The selected vector may represent a precoding configuration that best reflects the channel response. The UE may transmit CSI including PMI to the base station. The base station may perform optimal beamforming based on the PMI included in the CSI.

The PMI of the Type I codebook, which is included in the CSI transmitted by the UE to the base station, may be reported as a single PMI value and may allow the base station to use the same beamforming in an entire band. Accordingly, beamforming may be supported with a simple structure by the UE reporting, to the base station, the PMI over the entire frequency band. As described above, the PMI of the Type I codebook is suitable for a low-dimensional MIMO environment and has low feedback overhead.

For example, a Type I codebook defined in 3GPP Release 15 may be a single-panel codebook. As another example, a Type I codebook defined in 3GPP Release 15 may be a multi-panel codebook.

### [B] PMI Calculation According to a Type II Codebook

The Type II codebook is designed for high-dimensional MIMO systems and massive antenna array environments. The Type II codebook enables more precise beamforming reflecting frequency-selective characteristics. The Type II codebook is structured with a wideband PMI and a subband PMI, enabling detailed beam adjustment corresponding to each frequency band.

In the Type II codebook, the UE may measure a channel response through a CSI-RS transmitted from the base station, but the UE may perform measurement reflecting detailed characteristics of multiple antennas in a high-dimensional channel.

By using the wideband PMI, the UE may select an optimal precoding vector for a wide band. The UE may select a PMI reflecting average band characteristics by calculating a correlation between the channel response and each precoding vector over the entire band. The wideband PMI may represent a basic beam direction and may be applied across the entire frequency band.

The subband PMI may represent a detailed precoding vector configuration reflecting frequency-selective characteristics. The UE may calculate PMI individually for each subband, and in an environment with high frequency selectivity, the base station may perform detailed beam adjustment by using the subband PMI reported by the UE. The UE may select an optimal precoding vector by calculating a correlation between the channel response and a precoding vector for each subband.

Finally, the UE may separately report, to the base station, a selected wideband PMI and a subband PMI for each subband. Through such reporting, the base station may perform beamforming optimized for each frequency. Accordingly, the base station supports detailed beamforming reflecting frequency-selective characteristics through a combination of the wideband PMI and the subband PMI. By supporting such detailed beamforming, when a scheme using the Type II codebook is used, the base station may exhibit high transmission performance in a high-dimensional MIMO environment and may effectively reflect channel characteristics of a high-frequency band.

The codebook for CSI reporting may follow at least one of the following examples. For example, the codebook may follow a Type II port selection Type II codebook described in Chapter 5.2.2.2.3 of TS 38.214 of 3GPP Rel-15. As another example, the codebook may follow a port selection Type II codebook described in Chapter 5.2.2.2.4 of TS 38.214 of 3GPP Rel-15. As still another example, the codebook may follow an enhanced Type II codebook described in Chapter 5.2.2.2.5 of TS 38.214 of 3GPP Rel-16. As still another example, the codebook may follow an enhanced port selection Type II codebook described in Chapter 5.2.2.2.6 of TS 38.214 of 3GPP Rel-16. As still another example, the codebook may follow a further enhanced port selection Type II codebook described in Chapter 5.2.2.2.7 of TS 38.214 of 3GPP Rel-17.

Meanwhile, in 5G, when the base station transmits and receives data to and from the terminal in a band of 6 GHz or higher, in particular, an mm Wave band, coverage may be limited due to a propagation path loss. A problem due to a coverage limitation may be solved by densely arranging a plurality of relays between a propagation path from the base station and the terminal, but a very high cost problem for installing and operating relays may be caused accordingly.

A technology in which data transmission and reception between a base station and a terminal are supported by shifting a phase of a received signal and reflecting the received signal, amplifying and transmitting the received signal, or simultaneously performing amplification and phase shifts on a reconfigurable surface composed of a plurality of elements, instead of densely arranging relays, is referred to as a Reconfigurable Intelligent Surface (RIS). A node that receives data from a base station or a terminal and reflects the data to a counterpart node (e.g. from the base station to the terminal or from the terminal to the base station) is referred to as an RIS node. In order for the RIS node to transmit data by receiving the data, shifting a phase of the data, and amplifying and transmitting the data, transmission power for amplification at the RIS node needs to be optimized. Through optimization of the transmission power for amplification, unnecessary power consumption of the RIS node may be prevented, and uplink and/or downlink interference may be minimized.

In the present disclosure described below, methods in which a base station controls phase shifts and transmission powers for an RIS node are described. However, the present disclosure should not be understood as being limited to control of an RIS node by a base station. For example, the present disclosure may be applied to methods and apparatuses for controlling a specific RIS node by a terminal or another RIS node to configure phase shifts and transmission powers to be applied to the specific RIS node.

In addition, according to the present disclosure described below, a phase shift configuration may be determined not only for an RIS node but also for another relay node or an access point (AP) to prevent unnecessary power consumption and minimize interference. Such phase shifts and amplified power may be applied not only to a downlink signal but also to an uplink signal. Hereinafter, exemplary embodiments of the present disclosure are described through specific embodiments.

### First Exemplary Embodiment

In the first exemplary embodiment according to the present disclosure, an RIS node may receive data transmitted by a base station or a terminal and may perform phase shifts on the received data and/or change (e.g. amplify) a transmission power of the received data, to transmit (reflect) the received data to a counterpart node. In this case, phase shift information and/or transmission power information for the RIS node may be determined by the base station. In the first exemplary embodiment described below, methods of determining, by the base station, phase shift information and/or transmission power information for the RIS node and controlling the RIS node by transmitting the phase shift information and/or transmission power information to the RIS node are described.

### <Method 1 for Determining Phase Shifts and Transmission Powers for an RIS Node>

The base station may transmit phase shift information for an RIS node to the RIS node by transmitting only index information using a predefined codebook. When the RIS node is deployed to address a problem of specific communication shadow areas, the base station may compensate for the shadow areas by using the predefined codebook. In particular, when the RIS node includes a passive RIS and the RIS node supports a single UE, the RIS node may be configured with low overhead. In the present disclosure, the predefined codebook may be a codebook corresponding to phase shift information for the RIS node, and the predefined codebook may be configured in advance through higher-layer signaling between the base station and the RIS node, or may be defined in technical specifications.

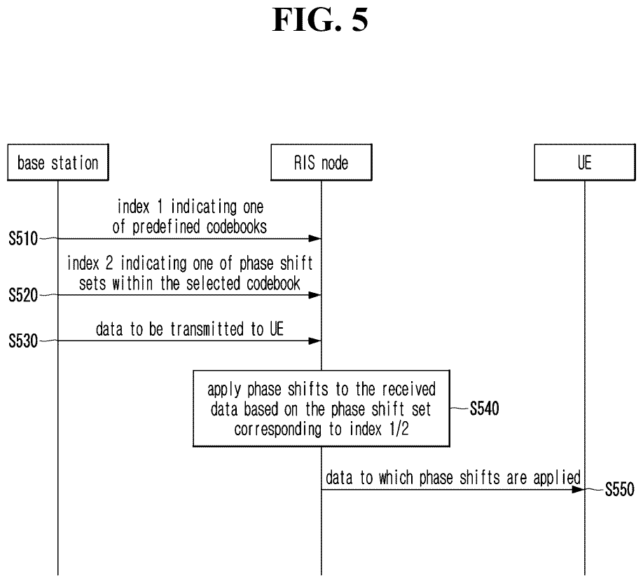

FIG. 5 is a sequence diagram illustrating transmission of data by applying phase shifts to an RIS node according to an exemplary embodiment of the present disclosure.

Before referring to FIG. 5, it should be noted that a base station and a UE may include all or part of the components illustrated in FIG. 2. The base station may further include an interface for communicating with a core network, another base station, and the like, in addition to the components illustrated in FIG. 2. The UE may further include components for user convenience, for example, various sensors, in addition to the components illustrated in FIG. 2. An RIS node may include at least the processor 210, the memory 220, and the transceiver 230 among the components illustrated in FIG. 2, and the RIS node may further include a reconfigurable surface composed of reflection elements as described above. In addition, the RIS node described in the present disclosure may be interpreted as an implementation example for improvement of an RF repeater or a network controlled repeater (NCR) used in a wireless communication system. For example, a terminal (i.e. UE) may operate in the same manner as direct communication with the base station without recognizing existence of the RIS node, and the base station may control phase shifts and transmission powers for a signal reflected and/or relayed via the RIS node.

In step S510, the base station may select one codebook among preconfigured codebooks. The base station may transmit an index (hereinafter, referred to as ‘index 1’) corresponding to the selected codebook in order to notify the RIS node of the selected codebook. As described above, the preconfigured codebooks may be shared through higher-layer signaling between the base station and the RIS node, or may be predefined in technical specifications. For example, the higher-layer signaling may include a configuration transmitted through a radio resource control (RRC) reconfiguration message or a system information block (SIB), and through the RRC reconfiguration message and/or SIB, an identifier (ID) of the codebook, a configuration of a phase shift set included in the codebook, and/or other parameters related to the codebook may be commonly configured for the base station and the RIS node.

In step S510, the RIS node may receive, from the base station, index 1 indicating one of the preconfigured codebooks. The RIS node may identify the codebook corresponding to index 1, and thereafter may be configured to perform phase shifts on data and/or signals transmitted by the base station by using the codebook corresponding to index 1.

Within one codebook, a plurality of phase shift sets may exist. In addition, each of the phase shift sets may include phase shift values of all reflection elements included in the RIS. Therefore, one of the plurality of phase shift sets needs to be selected.

In step S520, the base station may select one phase shift set among the plurality of phase shift sets within the selected codebook. The base station may transmit, to the RIS node, an index (hereinafter, referred to as ‘index 2’) corresponding to the phase shift set selected within the selected codebook.

In step S520, the RIS node may receive index 2 from the base station. The RIS node may identify the phase shift set corresponding to index 2 within the codebook corresponding to index 1. The RIS node may set phase shift values based on index 1 and index 2 for all reflection elements included in the RIS.

In the above description, the case in which index 1 indicating the codebook and index 2 indicating the phase shift set within the selected codebook are transmitted has been assumed. However, variations thereof may be possible. For example, when different indexes are assigned to respective phase shift sets included in respective codebooks, step S510 and step S520 may be replaced with a single step. For example, when only two codebooks exist, two phase shift sets are included in the first codebook, and two phase shift sets are also included in the second codebook, a codebook and a phase shift set may be indicated with 2 bits. In this case, it should be noted that step S510 and step S520 may be replaced with a single step.

In step S530, the base station may transmit data to be transmitted to the UE to the RIS node. The data transmitted to the RIS node may be configured by considering phase shift values for all reflection elements included in the RIS node.

In step S540, the RIS node may reflect the received data toward the UE by applying phase shifts to the received data based on the phase shift set corresponding to index 1 and index 2.

In step S550, the RIS node may transmit (or reflect), to the UE, the data to which the phase shifts have been applied. In step S550, the UE may receive the data from the RIS node.

According to the procedure described above, the UE located in a shadow area or at a position where direct reception of data from the base station is difficult may receive the data from the base station via the RIS node.

Meanwhile, index 1 described in step S510 and step S520 may also be referred to as a codebook index, and index 2 may also be referred to as a selection index. Index 1 and index 2 according to the present disclosure may be transmitted from the base station to the RIS node through physical-layer signaling. Accordingly, when channel conditions between the UE and the RIS node and/or between the RIS node and the base station change rapidly, index 1 and index 2 may be changed in real time. For example, the physical-layer signaling may be implemented through one or more fields included in DCI, and the field(s) included in the DCI may indicate index 1 and index 2 or a single index corresponding to index 1 and index 2.

As another example, index 1 may be transmitted from the base station to the RIS node through higher-layer signaling, and index 2 may be transmitted from the base station to the RIS node through physical-layer signaling. In this case, index 1 may be changed periodically or semi-periodically. In this manner, when only index 2 for selecting a phase shift set to be used within one codebook is transmitted to the RIS node through physical-layer signaling, the phase shift set may be changed in real time and overhead may be reduced.

Meanwhile, FIG. 5 illustrates only one UE receiving data from the base station via the RIS node as an example, but it should be noted that the example of FIG. 5 may be applied in the same manner to two or more UEs. In addition, the above description has been provided by exemplifying transmission from the base station to the UE (i.e. downlink transmission), but the same or similar description may be applied to transmission in an opposite direction (i.e. uplink transmission). For example, when an uplink signal transmitted from the UE to the base station is transmitted via the RIS node, the base station may indicate, to the RIS node, a phase shift set and a transmission power configuration to be applied to an uplink path by using index 1 and index 2, or an index corresponding to index 1 and index 2.

### <Method 2 for Determining Phase Shifts and Transmission Powers for an RIS Node>

The base station may transmit phase shift information and transmission power information to an RIS node by using a preconfigured codebook. As in Method 1 for determining phase shifts and transmission powers of an RIS node described above, when the RIS node is deployed to address a communication shadow area problem of the base station, smooth communication may be achieved with a predefined codebook even when a UE is located in a predetermined shadow area. However, when the RIS node supports a passive RIS, an active RIS, and/or multiple users, use of Method 1 described above may cause a large amount of overhead. In particular, when multiple users are supported, a transmission power needs to be determined differently for each reflection element of the RIS node in order to minimize interference and improve performance. Therefore, the base station needs to deliver, to the RIS node, a transmission power value for each reflection element or for each phase shift set.

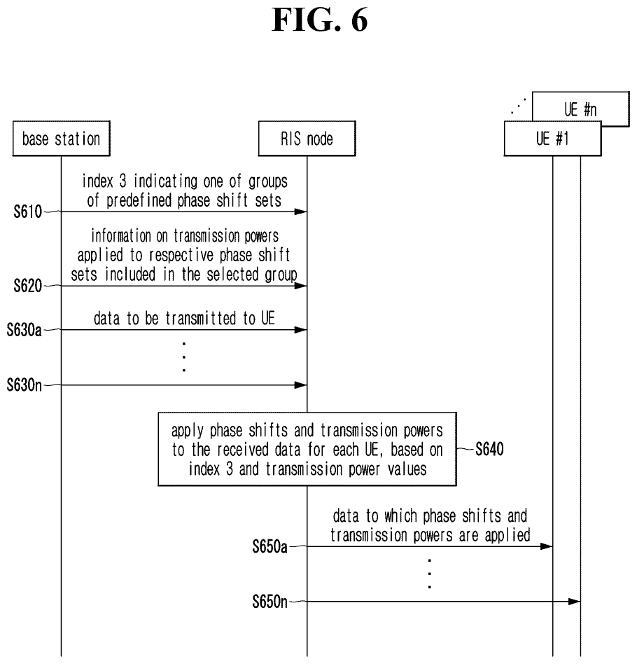

FIG. 6 is a sequence diagram illustrating a first exemplary embodiment of the present disclosure in which an RIS node applies phase shifts and transmission powers to transmit data.

Before referring to FIG. 6, it should be noted that each of a base station and UEs UE #1 to UE #n may include all or part of the components illustrated in FIG. 2. The base station may further include, in addition to the components illustrated in FIG. 2, an interface for communicating with a core network, another base station, and the like. Each of the UEs UE #1 to UE #n may further include, in addition to the components illustrated in FIG. 2, components for user convenience, for example, various sensors. The RIS node may include at least the processor 210, the memory 220, and the transceiver 230 among the components illustrated in FIG. 2, and as described above, may further include a reconfigurable surface composed of reflection elements.

In step S610, the base station may select one phase shift set group among groups of predefined phase shift sets. The base station may transmit, to the RIS node, an index (hereinafter, referred to as ‘index 3’) indicating the selected phase shift set group in order to notify the RIS node of the selected phase shift set group.

As described above, the base station and the RIS node may have a plurality of codebooks through higher-layer signaling, and each of the plurality of codebooks may include one or more phase shift sets. In the present disclosure, one or more phase shift sets included in each of the plurality of codebooks may be configured as groups. A brief example thereof is described as follows.

It is assumed that the number of codebooks shared between the base station and the RIS node or defined in technical specifications is two, and the two codebooks are referred to as codebook #1 and codebook #2. When three phase shift sets are configured in each of codebook #1 and codebook #2, phase shift sets of the respective codebooks may be classified as follows.

The phase shift sets may be classified into phase shift set #1 of codebook #1, phase shift set #2 of codebook #1, phase shift set #3 of codebook #1, phase shift set #1 of codebook #2, phase shift set #2 of codebook #2, and phase shift set #3 of codebook #2. In this case, when two phase shift sets are included in one phase shift set group, respective groups may be configured as follows.

Phase shift group #1 may be composed of phase shift set #1 of codebook #1 and phase shift set #2 of codebook #1, phase shift group #2 may be composed of phase shift set #1 of codebook #1 and phase shift set #3 of codebook #1, phase shift group #3 may be composed of phase shift set #2 of codebook #1 and phase shift set #3 of codebook #1, phase shift group #4 may be composed of phase shift set #1 of codebook #1 and phase shift set #1 of codebook #2, . . . , and phase shift group #15 may be composed of phase shift set #2 of codebook #2 and phase shift set #3 of codebook #2.

In step S610, the base station may select index 3 corresponding to the phase shift set group as described above, may transmit the selected index 3 to the RIS node, and the RIS node may receive index 3. Based on the received index 3, the RIS node may identify codebook(s) to be used and phase shift sets selected from the codebook(s).

In step S620, the base station may determine a transmission power value to be applied (i.e. multiplied) to each of the phase shift sets. The base station may transmit the transmission power value to the RIS node. Instead of the transmission power value to be applied (i.e. multiplied) to each of the phase shift sets, the base station may transmit, to the RIS node, a transmission power value to be applied to each reflection element included in the RIS node. Accordingly, in step S620, the RIS node may receive, from the base station, the transmission power value to be applied to each of the phase shift sets or the transmission power value to be applied to each of the reflection elements included in the RIS node.

In step S630a to step S630n, the base station may transmit, to the RIS node, data to be transmitted to UE(s). The case in which the base station transmits data to be transmitted to the UE to the RIS node may correspond to a case in which the UE is located in a shadow area of the base station as described above. Various cases of using the RIS node may exist in addition to the case in which the UE is located in a shadow area of the base station. In the following description, it should be noted that, as one example for facilitating understanding of the present disclosure, a case in which the UE is located in a shadow area of the base station is assumed. In addition, illustrating step S630a to step S630n assumes a case in which the number of UEs communicating in the shadow area of the base station is n. When only one UE exists that is communicating in the shadow area of the base station, step S630a to step S630n may be understood as a single step, and when two UEs exist that are communicating in the shadow area of the base station, step S630a to step S630b may be understood as two steps.

The RIS node may receive, from the base station, data to be transmitted to the UE in step S630a to step S630n.

In step S640, the RIS node may apply the group of phase shift sets and transmission power values corresponding to the respective phase shift sets, which are received from the base station in steps S610 and S620, to the received data (or channel).

In step S650a to step S650n, the RIS node may transmit, to the UEs UE #1 to UE #n, the data to which the phase shifts and transmission powers are applied.

Dividing operations of the RIS node described above into step S630a to step S630n, step S640, and step S650 is for describing a procedural flow. Since the RIS node has obtained the group of phase shift sets and the transmission power values applied to the respective phase shift sets received from the base station in step S610 and step S620, the RIS node may immediately transmit (or reflect) the received data (or channel) to the corresponding UEs by applying the phase shifts and transmission powers.

As described above, index 3 transmitted from the base station to the RIS node in step S610 may be transmitted through physical-layer control signaling, and the transmission power values for the respective phase shift sets or the transmission power values for the respective reflection elements of the RIS node, which are transmitted from the base station to the RIS node in step S620, may be transmitted through physical-layer data signaling. For example, the physical-layer control signaling may be implemented through a specific DCI format or a MAC control element (CE), and the physical-layer data signaling may be implemented through a transmission power information field included in one or more transport blocks delivered through a downlink data channel. In this case, index 3 may operate as a repeater configuration index implying a group of phase shift sets and a basic transmission power configuration to be applied to each phase shift set. Since index 3 has small overhead, index 3 may be transmitted from the base station to the RIS node through physical-layer control signaling, but since the transmission power to be multiplied to the phase shift set may have large overhead, the transmission power may be transmitted through physical-layer data signaling.

As another example, both index 3 and transmission power values for respective phase shift sets transmitted in step S610 may be conveyed from the base station to the RIS node through physical-layer control signaling. When the transmission power values for the respective phase shift sets are conveyed through physical-layer control signaling, the RIS node may accumulate the transmission power values and apply the accumulated transmission power values to the corresponding phase shift set or to all reflection elements included in the RIS node.

As described above, since the RIS node is deployed to support services in communication shadow areas, a channel environment for multiple users within a limited shadow area may not change abruptly. Accordingly, rather than drastically changing transmission powers for respective phase shift sets, the transmission powers may be determined through fine-grained adjustments. Therefore, an initial configuration may be provided through higher-layer signaling, and transmission powers for the respective sets may be cumulatively configured through physical-layer control signaling.

For example, it is assumed that a total of 16 phase shift set groups exist, one group including four phase shift sets is configured through group index 3, and an existing power is set for each phase shift set, where an initial power is set through higher-layer signaling. In this case, the base station may select, through physical-layer control signaling, one specific transmission power value (e.g. one of +3 dB, +1 dB, −1 dB, and −3 dB) for each of the four phase shift sets or for all of the four phase shift sets, and may transmit the selected transmission power value to the RIS node. The RIS node may receive the physical-layer control signaling and may cumulatively increase or decrease the existing power by adding the received value to the existing power. The values+3 dB, +1 dB, −1 dB, and −3 dB exemplified above are merely examples for facilitating understanding of the present disclosure, and other modified values may be used.

Meanwhile, in the exemplary embodiment of FIG. 6, a plurality of UEs receiving data from the base station via the RIS node have been described, but it should be noted that a case in which data is transmitted to one UE may be understood in the same manner.

### <Method 3 for Determining Phase Shifts and Transmission Powers for an RIS Node>

In wireless environments of a mobile communication system, in order to rapidly support services via an RIS node, using a preconfigured codebook as described above may be the most preferable method. However, in order to rapidly support services in various wireless environments, changes may need to be made in real time without using a preconfigured codebook. When a codebook is not used, overhead may significantly increase in a case in which the base station configures a phase shift for the RIS node.

The present disclosure provides methods for the base station to configure phase shifts for the RIS node without using a codebook.

According to an exemplary embodiment of the present disclosure, the base station may transmit phase shift information for each reflection element included in the RIS node through physical-layer control signaling. For phase shift information per reflection element in the physical-layer control signaling, n bits may be used. Here, n may be a natural number equal to or greater than 1.

The base station may configure a phase shift for each reflection element included in the RIS node by using n bits. For example, when a phase shift per reflection element is configured for the RIS node using 1 bit, a phase shift value may be configured by using a 1-bit value. When the 1-bit value is 0, the RIS node may be configured to perform a phase shift by θ₀ degrees for the corresponding reflection element, and when the 1-bit value is 1, the RIS node may be configured to perform a phase shift by θ₁ degrees. In this case, the values θ₀ and θ₁ may be predefined or may be configured through higher-layer signaling.

For transmission power, a cumulative scheme may be used as described above in Method 2. In other words, an initial value multiplied to each reflection element may be transmitted from the base station to the RIS node through higher-layer signaling. Thereafter, the base station may transmit, to the RIS node, a transmission power to be multiplied to each reflection element through physical-layer control signaling. The RIS node may cumulatively update the transmission power by adding the transmission power received through physical-layer control signaling from the base station to a previous value.

For example, a case is assumed in which there are 16 reflection elements included in the RIS node. In a state in which an initial power is set for each reflection element included in the RIS node (i.e. the initial power is set through higher-layer signaling), a specific power value for each of the 16 reflection elements may be transmitted through physical-layer control signaling. The specific power value may be, for example, one of +3 dB and −3 dB. The values +3 dB and −3 dB are values exemplified for facilitating understanding of the present disclosure, and it should be noted that other values may be configured.

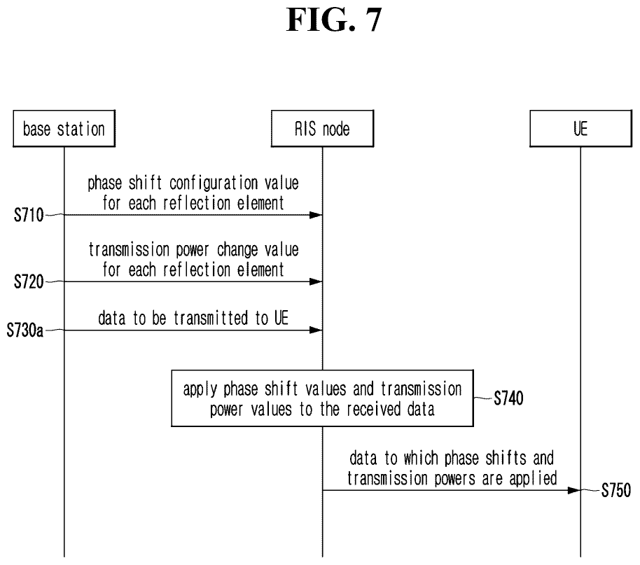

FIG. 7 is a sequence diagram illustrating a second exemplary embodiment of the present disclosure in which an RIS node applies phase shifts and transmission powers to transmit data.

Before referring to FIG. 7, it should be noted that a base station and a UE may include all or part of the components illustrated in FIG. 2. The base station may further include, in addition to the components illustrated in FIG. 2, an interface for communicating with a core network, another base station, and the like. The UE may further include, in addition to the components illustrated in FIG. 2, components for user convenience, for example, various sensors. The RIS node may include at least the processor 210, the memory 220, and the transceiver 230 among the components illustrated in FIG. 2, and as described above, may further include a reconfigurable surface composed of reflection elements.

In step S710, the base station may configure a phase shift value for each reflection element included in the RIS node. Assuming that the number of reflection elements included in the RIS node is M and that each phase shift value have a length of n bits, phase shift values transmitted by the base station to the RIS node may be M*n bits. Here, M and n may be natural numbers equal to or greater than 1. The base station may transmit, to the RIS node, the phase shift values for the respective reflection elements configured in step S710.

In step S710, the RIS node may receive, from the base station, the phase shift values for the respective reflection elements. The RIS node may reflect (e.g. apply) the phase shift values for the respective reflection elements to the respective reflection elements of the RIS node.

In step S720, the base station may configure a transmission power change value for each reflection element included in the RIS node. The transmission power change value for each reflection element may have a length of p bits. Here, p may be a natural number equal to or greater than 1, and p may be the same as or different from n in step S710. The base station may transmit, to the RIS node, the transmission power change value for each reflection element configured in step S720.

Although not illustrated in FIG. 7, the base station may transmit an initial transmission power value for each reflection element to the RIS node in advance through higher-layer signaling. Accordingly, the RIS node may apply the initial transmission power value to each reflection element included in the RIS node. When the UE is communicating with the base station via the RIS node, a specific transmission power value may be configured for each reflection element included in the RIS node. In this case, the specific transmission power value for each reflection element may be obtained by changing the initial transmission power value based on the transmission power change value for each reflection element received in step S720.

In step S720, the RIS node may receive, from the base station, a transmission power change value for each reflection element included in the RIS node. The RIS node may cumulatively apply the transmission power change value received from the base station to an existing power value for each reflection element. When an update from an initially configured value is performed, the existing transmission power value for each reflection element may correspond to a transmission power value received through higher-layer signaling as described above. When no update from the initially configured value is performed, the existing transmission power value for each reflection element may correspond to a transmission power value obtained through a previous execution of step S720.

In step S730, the base station may transmit, to the RIS node, data (or channel) to be transmitted to the UE. When the RIS node receives data (or channel) to be transmitted to the UE in step S730, the RIS node may apply phase shift values and transmission power values configured for the respective reflection elements included in the RIS node in step S740.

In step S750, the RIS node may transmit (or reflect), to the UE, data (or channel) to which the phase shift values and the transmission power values are applied. In step S750, the UE located in the shadow area of the base station may receive, from the RIS node, the data (or channel) to which the phase shift values and the transmission powers are applied by the RIS node.

The phase shift configuration method and the transmission power configuration method described above may control the RIS node by the UE or another RIS node. When the UE or a second RIS node controls a first RIS node, the first RIS node may configure phase shift values and transmission power values based on physical-layer signaling or higher-layer signaling transmitted from the UE or the second RIS node to the first RIS node. The phase shift values and transmission power values for the first RIS node may be determined based on one or more physical-layer signaling signals or higher-layer signaling signals.

Meanwhile, FIG. 7 illustrates only one UE receiving data from the base station via the RIS node as an example, but it should be noted that the example of FIG. 7 may be applied in the same manner to two or more UEs.

### Second Exemplary Embodiment

In the second exemplary embodiment according to the present disclosure, methods for a base station to indicate, to an RIS node, which method is to be used to configure phase shift values and transmission power values among the methods for configuring phase shifts and transmission powers are described.

As in the first exemplary embodiment described above, in the second exemplary embodiment, a method of configuring phase shift values and transmission power values may vary according to various situations. For example, transmission power change may be required or may not be required depending on whether the RIS node is a passive RIS node or an active RIS node. In addition, depending on whether the RIS node supports multiple users or supports a single user, overhead required for configuration may vary according to whether phase shift values and transmission power values need to be precisely configured or simply configured.

For example, each method described in the first exemplary embodiment (i.e. Method 1 for determining phase shifts and transmission powers for an RIS node to Method 3 for determining phase shifts and transmission powers for an RIS node) has advantages and disadvantages. Accordingly, depending on a situation, the base station may determine and apply one of the methods described above, and may dynamically switch the applied method to another method in response to changes in a communication environment.

When the RIS node supports a single user and the RIS node includes a passive RIS, if the RIS node is configured using Method 1 described in the first exemplary embodiment, overhead may be reduced, and communication performance between the UE and the base station using the RIS node may also be excellent.

When the RIS node supports multiple users and the RIS node includes an active RIS, the RIS node needs to be configured using Method 2 described in the first exemplary embodiment so that an appropriate improvement can be obtained between the base station and the UE via the RIS node.

In a situation in which a wireless channel environment between the base station and the RIS node and/or between the RIS node and the UE changes rapidly, when Method 3 of the first exemplary embodiment described above is used, relatively excellent performance compared to other methods may be obtained by changing phase shift values and/or transmission power values more frequently with smaller overhead.

Accordingly, depending on a role and a situation of the RIS node, methods of configuring phase shift values and transmission power values need to be changed. Hereinafter, methods for receiving information on which method is to be used among several methods for the RIS node to configure phase shift values and transmission power values from the base station are described.

### <Situation-Specific Configuration Method 1>

The base station may distinguish a method to be used through n bits in physical-layer control signaling (e.g. PDCCH). For example, in order to distinguish three methods described in the first exemplary embodiment, the base station may indicate one of Method 1, Method 2, and Method 3 by using 2 bits. Accordingly, the RIS node may identify a method to be applied by using a 2-bit value.

### <Situation-Specific Configuration Method 2>

The base station may distinguish, through 1 bit in physical-layer control signaling (e.g. PDCCH), whether to consider transmission powers or not to consider transmission powers. Distinguishing other methods may be implicitly performed through a format of the physical-layer control signaling.

For example, Method 1 and Method 2 described in the first exemplary embodiment may be distinguished through 1 bit of the physical-layer control signaling, and Method 3 may be implicitly distinguished.

In Method 1 and Method 2, a combination of a codebook index and a selection index may be transmitted, or a group index may be transmitted. Since a bitmap for the respective reflection elements may be transmitted in Method 3, a physical-layer control signaling format needs to have a different structure so that the base station transmits phase shift values and transmission power values to the RIS node. In case of an index, many bits are not used and the number of bits can be fixed, but in case of a bitmap for Method 3, since the bitmap needs to be changed according to the number of reflection elements of the RIS node, the physical-layer control signaling format needs to be different so that the base station can transmit phase shifts and transmission powers to the RIS node.

### <Situation-Specific Configuration Method 3>

Based on a format of physical-layer control signaling, Method 1 and Method 2 may be implicitly distinguished from Method 3. For example, since the three methods described above in the first exemplary embodiment require different formats when index(es) or a bitmap is delivered through physical-layer control signaling, the base station may implicitly notify the RIS node of a method used through a format transmitted from the base station to the RIS node.

When a phase shift and transmission power configuration method is determined through one of the situation-specific configuration methods described above, the base station may deliver, to the RIS node, phase shift values and transmission power values corresponding to the determined method. Accordingly, the RIS node may apply, to a signal transmitted to the UE, the phase shift values and the transmission power values received from the base station, and may transmit (or reflect) the signal to the UE.

The situation-specific phase shift and transmission power configuration methods described above may be controlled not only by the base station but also by the UE or another RIS node. For example, when the UE or a second RIS node controls a first RIS node, based on the physical-layer signaling or higher-layer signaling signal described above, the UE or the second RIS node may cause the first RIS node to determine a phase shift and transmission power configuration method, and may also deliver phase shift values and/or transmission power values. In this case, the method described above may be applied based on one or more physical-layer signaling signals or higher-layer signaling signals transmitted from the UE or the second RIS node to the first RIS node.

### Third Exemplary Embodiment

In the third exemplary embodiment described below, methods of determining how the RIS node applies phase shift information (or phase shift values) and transmission power information (or transmission power values) received from the base station are described.

The base station may update phase shift information and/or transmission power information for the RIS node. The RIS node needs to know based on which information the RIS node determine phase shift values and transmission power values.

### <Phase Shift and Transmission Power Update Method 1>

There may be a case where the RIS node does not receive, from the base station, information on a phase shift and transmission power determination method to be used. In this case, the RIS node may update phase shift values most recently received from the base station and transmission power values most recently received from the base station, respectively.

For example, when the RIS node receives, from the base station, data (or channel) to be transmitted to the UE in a state in which information most recently received from the base station are only phase shift values, the RIS node may configure reflection elements to perform phase shifts on the received data based on the phase shift values received from the base station. However, the RIS node may be unable to determine transmission power values for the received data. In this case, in determining transmission power values for the received data, the RIS node may apply transmission power values updated prior to the current time so that the received data is transmitted (or reflected) to the UE.

In the same manner, when the RIS node receives, from the base station, data to be transmitted to the UE in a state in which information most recently received from the base station is only transmission power information (or transmission power values), the RIS node may configure reflection elements with transmission power values according to the transmission power information received from the base station. However, the RIS node may be unable to configure phase shift values for the received data. In this case, in determining phase shift values for the received data, the RIS node may apply phase shift values updated prior to the current time so that the received data is transmitted (or reflected) to the UE.

Meanwhile, when information most recently received from the base station includes both phase shift information and transmission power information, the RIS node may transmit (or reflect) data received from the base station to the UE based on the information most recently received from the base station.

### <Phase Shift and Transmission Power Update Method 2>

There may be a case where the RIS node does not receive, from the base station, information on a phase shift and transmission power determination method to be used. In this case, the RIS node may update only values most recently received from the base station.

For example, when information most recently received from the base station includes only phase shift information, the RIS node may configure reflection elements with phase shift values by using the phase shift information received from the base station. In this case, since no transmission power information most recently received from the base station exists, in determining transmission power, the RIS node may configure reflection elements with preconfigured transmission power values (e.g. values received through RRC signaling or predefined specific values).

As another example, when information most recently received from the base station includes only transmission power information, the RIS node may configure reflection elements with transmission power values based on the transmission power information received from the base station. In this case, since no phase shift values most recently received from the base station exist, in determining phase shift values, the RIS node may configure reflection elements with preconfigured phase shift values (e.g. values received through RRC signaling or predefined specific values).

When both phase shift information most recently received from the base station and transmission power information most recently received from the base station exist, the RIS node may configure reflection elements with phase shift values and transmission power values based on the information received from the base station.

### <Phase Shift and Transmission Power Update Method 3>

According to an exemplary embodiment, a phase shift determination method and a transmission power determination method may be independent from each other.

When a phase shift determination method and a transmission power determination method are distinguished, an operation of the RIS node may be different. When a phase shift determination method and a transmission power determination method are distinguished, Method 1 and Method 2 described above may be distinguished and applied according to a distinguishing method.

For example, when configuration is performed with Method 1 described above in the first exemplary embodiment, since phase shift information is updated rather than transmission power information, as in the phase shift and power update method 2 described in the third exemplary embodiment, only phase shift information may be updated, and predefined transmission power values may be used as transmission power values.

As another example, when configuration is performed with Method 2 described above in the first exemplary embodiment, since both phase shift information and transmission power information are updated, configuration needs to be performed as in the phase shift and transmission power update method 1 described in the third exemplary embodiment.

As still another example, when configuration is performed with Method 3 described above in the first exemplary embodiment, both phase shift information and transmission power information may be configured, or only phase shift information may be configured. Accordingly, through higher-layer signaling, the base station may configure, for the RIS node, whether to be configured with the phase shift and transmission power update method 1 or the phase shift and transmission power update method 2 described in the third exemplary embodiment. As another method, together with phase shift information configuration, the base station may configure, for the RIS node, whether to be configured with the phase shift and transmission power update method 1 or the phase shift and transmission power update method 2.

The phase shift and transmission power update methods have been described by assuming a case in which the base station configures the phase shift and transmission power update method for the RIS node. However, another RIS node may configure a phase shift and transmission power update method for a certain RIS node, or the UE may configure a phase shift and transmission power update method for the RIS node. In this case, as described above, physical-layer signaling and/or higher-layer signaling may be used.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a Reconfigurable Intelligent Surface (RIS) node, the method comprising:
receiving, from a first communication node, first information indicating a phase shift determination scheme;
based on the first information indicating use of a codebook as the phase shift determination scheme, receiving, from the first communication node, information on a phase shift set for phase shifts;
setting phase shift values for respective reflection elements based on the phase shift set; and
upon receiving data to be transmitted from the first communication node to a second communication node, reflecting the received data toward the second communication node based on the phase shift values set for the respective reflection elements.

2. The method of claim 1, wherein the receiving of the information on the phase shift set comprises:
receiving a first index indicating one codebook from among two or more codebooks; and
receiving a second index indicating one phase shift set from among two or more phase shift sets included in the one codebook corresponding to the first index,
wherein the phase shift values are set based on the first index and the second index.

3. The method of claim 2, further comprising: receiving, from the first communication node, the two or more codebooks through higher-layer signaling.

4. The method of claim 1, wherein the receiving of the information on the phase shift set comprises:
receiving a group index indicating one phase shift set group among one or more phase shift set groups each including one or more phase shift sets; and
receiving information on transmission powers respectively applied to one or more phase shift sets included in the one phase shift set group indicated by the group index,
wherein the received data is reflected toward the second communication node based on phase shift values set according to the group index and the information on the transmission powers.

5. The method of claim 4, further comprising: receiving, from the first communication node, information corresponding to the one or more phase shift set groups each including one or more phase shift sets through higher-layer signaling.

6. The method of claim 1, wherein the first information further indicates a transmission power determination scheme, and the reflecting comprises:
setting, in the transmission power determination scheme indicated by the first information, phase shift values and transmission power values for the respective reflection elements; and
reflecting the received data toward the second communication node based on the phase shift values and transmission power values set for the respective reflection elements.

7. The method of claim 1, further comprising:
based on the first information indicating non-use of a codebook as the phase shift determination scheme, receiving, from the first communication node, phase shift values for the respective reflection elements; and
upon receiving data to be transmitted from the first communication node to the second based on the phase shift values for the respective reflection elements.

8. The method of claim 7, further comprising: based on the first information further indicating a transmission power determination scheme and the first information indicating non-use of a codebook as the transmission power determination scheme, receiving, from the first communication node, information on transmission power values corresponding to the respective reflection elements,
wherein the received data is reflected toward the second communication node based on the transmission power values corresponding to the respective reflection elements and the phase shift values for the respective reflection elements.

9. The method of claim 1, wherein the second communication node is a user equipment (UE) based on the first communication node being a base station, and the second communication node is a base station based on the first communication node being a UE.

10. The method of claim 1, wherein the first information further indicates a transmission power determination scheme, and the reflecting comprises:
determining, in the transmission power determination scheme indicated by the first information, transmission power values corresponding to the respective reflection elements; and
reflecting the received data toward the second communication node based on the phase shift values and the transmission power values for the respective reflection elements.

11. The method of claim 10, wherein the first information is one bit indicating whether the phase shift determination scheme and/or the transmission power determination scheme uses a codebook.

12. A method of a first communication node, the method comprising:
transmitting, to a Reconfigurable Intelligent Surface (RIS) node, first information indicating a phase shift determination scheme;
transmitting, to the RIS node, information on a phase shift set for phase shifts;
generating data to be transmitted to a second communication node based on the phase shift set; and
transmitting the generated data to the RIS node.

13. The method of claim 12, wherein the first information indicates use of a codebook as the phase shift determination scheme, and the transmitting of the information on the phase shift set comprises:
transmitting, to the RIS node, a first index indicating one codebook from among two or more codebooks; and
transmitting, to the RIS node, a second index indicating one phase shift set from among two or more phase shift sets included in the codebook indicated by the first index.

14. The method of claim 13, further comprising: transmitting, to the RIS node, information indicating the two or more codebooks through higher-layer signaling.

15. The method of claim 12, wherein the transmitting of the information on the phase shift set comprises:
transmitting, to the RIS node, a group index indicating one phase shift set group from among one or more phase shift set groups each including one or more phase shift sets; and
transmitting, to the RIS node, information on transmission powers respectively applied to one or more phase shift sets included in the phase shift set group indicated by the group index.

16. The method of claim 15, further comprising: transmitting, to the RIS node, information corresponding to the one or more phase shift set groups through higher-layer signaling.

17. The method of claim 12, further comprising: based on the first information indicating non-use of a codebook as the phase shift determination scheme, transmitting, to the RIS node, phase shift values for respective reflection elements of the RIS node.

18. The method of claim 17, further comprising: based on the first information further indicating a transmission power determination scheme, and the transmission power determination scheme indicating non-use of a codebook, transmitting, to the RIS node, transmission power values corresponding to the respective reflection elements of the RIS node.

19. A Reconfigurable Intelligent Surface (RIS) node comprising at least one processor, wherein the at least one processor causes the RIS node to perform:
receiving, from a first communication node, first information indicating a phase shift determination scheme;
based on the first information indicating use of a codebook as the phase shift determination scheme, receiving, from the first communication node, information on a phase shift set for phase shifts;
setting phase shift values for respective reflection elements based on the phase shift set; and
upon receiving data to be transmitted from the first communication node to a second based on the phase shift values set for the respective reflection elements.

20. The RIS node of claim 19, wherein the at least one processor causes the RIS node to perform:
receiving a first index indicating one codebook from among two or more codebooks; and
receiving a second index indicating one phase shift set from among two or more phase shift sets included in the one codebook corresponding to the first index,
wherein the phase shift values are set based on the first index and the second index.
